(19) United States
(12) Patent Application Publication
(10) Pub. No.: US 2026/0276883 A1
(43) Pub. Date: Sep. 17, 2026

(54) OPTICAL FIBER, OPTICAL FIBER RIBBON, AND OPTICAL FIBER CABLE

(71) Applicant: SUMITOMO ELECTRIC INDUSTRIES, LTD., Osaka (JP)

(72) Inventors: Noriaki IWAGUCHI, Osaka (JP); Katsushi HAMAKUBO, Osaka (JP); Miho IKEGAWA, Osaka (JP); Chiaki TOKUDA, Osaka (JP)

(21) Appl. No.: 19/472,845

(22) PCT Filed: Mar. 22, 2024
(86) PCT No.: PCT/JP2024/011441

§ 371 Date: Oct. 6, 2025

(30) Foreign Application Priority Data
Apr. 21, 2023 (JP) 2023-069970

(51) Int. Cl. G02B 6/02; G02B 6/44

(52) U.S. Cl. CPC G02B 6/02395; G02B 6/4403

(57) ABSTRACT

An optical fiber according to the present disclosure includes a glass fiber including a core and a cladding, and a coating resin layer covering the glass fiber, in which the coating resin layer has a primary resin layer coating the glass fiber in contact with the glass fiber, a secondary resin layer coating the primary resin layer, and a colored resin layer coating the secondary resin layer, the colored resin layer contains surface-treated titanium oxide particles in an amount of 1.1% by mass or more and 10% by mass or less based on the total amount of the colored resin layer, and the gel fraction retention ratio of the coating resin layer after the optical fiber is subjected to a damp heat test for 60 days in an environment at a temperature of 85° C. and a humidity of 85% is 80% or more.

### TECHNICAL FIELD

The present disclosure relates to an optical fiber, an optical fiber ribbon, and an optical fiber cable.

The present application claims priority based on Japanese Patent Application No. 2023-069970, filed on Apr. 21, 2023, the entire disclosure of which is incorporated herein by reference.

### BACKGROUND ART

In general, an optical fiber has a coating resin layer for protecting a glass fiber, which is an optical transmission medium. The coating resin layer has, for example, a primary resin layer that is in contact with the glass fiber, and a secondary resin layer formed on the outer peripheral surface of the primary resin layer, and the outermost layer of the coating resin layer is composed of a colored resin layer for distinguishing the optical fiber (see, for example, Patent Literatures 1 and 2).

### CITATION LIST

### Patent Literature

Patent Literature 1: JP H6-242355 A
Patent Literature 2: WO 2016/047002 A1

### SUMMARY OF INVENTION

An optical fiber according to an embodiment of the present disclosure includes a glass fiber including a core and a cladding, and a coating resin layer covering the glass fiber, in which the coating resin layer has a primary resin layer coating the glass fiber in contact with the glass fiber, a secondary resin layer coating the primary resin layer, and a colored resin layer coating the secondary resin layer, the colored resin layer contains surface-treated titanium oxide particles in an amount of 1.1% by mass or more and 10% by mass or less based on a total amount of the colored resin layer, and a gel fraction retention ratio of the coating resin layer after the optical fiber is subjected to a damp heat test for 60 days in an environment at a temperature of 85° C. and a humidity of 85% is 80% or more.

### BRIEF DESCRIPTION OF DRAWINGS

FIG. 1 is a schematic cross-sectional view showing an example of an optical fiber according to the present embodiment.

FIG. 2 is a schematic cross-sectional view showing an example of an optical fiber ribbon according to the present embodiment.

FIG. 3 is a schematic cross-sectional view showing an example of an optical fiber cable according to the present embodiment.

### DESCRIPTION OF EMBODIMENTS

### Problem to be Solved by Present Disclosure

In recent years, there has been an increasing demand for high-density cables with an increased packing density of optical fibers for data center applications. When the packing density of optical fibers within a cable increases, it is advantageous to make the outer diameter of the optical fibers smaller. In order to make the outer diameter of the optical fibers smaller, it may be considered to reduce the thickness of the coating resin layer; however, it would be difficult to distinguish the optical fibers. Furthermore, as the coating resin layer deteriorates over time in a hot and humid environment, the color of the optical fibers turns yellowish, and the distinguishability of the optical fibers may deteriorate. In particular, a colored resin layer containing titanium oxide tends to easily turn yellowish due to the catalytic activity of titanium oxide.

It is an object of the present disclosure to provide an optical fiber having excellent distinguishability, an optical fiber ribbon which uses the optical fiber, and an optical fiber cable.

### Effects of Present Disclosure

According to the present disclosure, an optical fiber having excellent distinguishability, an optical fiber ribbon which uses the optical fiber, and an optical fiber cable can be provided.

### Description of Embodiments of Present Disclosure

First, the contents of embodiments of the present disclosure will be listed and described.
(1) An optical fiber according to an embodiment of the present disclosure includes a glass fiber including a core and a cladding, and a coating resin layer covering the glass fiber, in which the coating resin layer has a primary resin layer coating the glass fiber in contact with the glass fiber, a secondary resin layer coating the primary resin layer, and a colored resin layer coating the secondary resin layer, the colored resin layer contains surface-treated titanium oxide particles in an amount of 1.1% by mass or more and 10% by mass or less based on a total amount of the colored resin layer, and a gel fraction retention ratio of the coating resin layer after the optical fiber is subjected to a damp heat test for 60 days in an environment at a temperature of 85° C. and a humidity of 85% is 80% or more.

In the optical fiber according to the present disclosure, by incorporating a specific amount of surface-treated titanium oxide particles into the colored resin layer, deterioration of the distinguishability of the optical fiber after the damp heat test can be suppressed.
(2) With regard to the above-described item (1), from the viewpoint of increasing the packing density of the optical fiber, the colored resin layer may have a thickness of 2 μm or more and 10 μm or less.
(3) With regard to the above-described item (1) or (2), from the viewpoint of improving the weather resistance of the coating resin layer, the surface-treated titanium oxide particles may have a surface treatment layer containing at least one selected from the group consisting of aluminum oxide, silicon dioxide, and zirconium dioxide.
(4) With regard to the above-described item (3), from the viewpoint of further improving the distinguishability of the optical fiber, the surface-treated titanium oxide particles have a surface treatment layer containing aluminum oxide, and a content of the aluminum oxide in the surface-treated titanium oxide particles may be 1% by mass or more and 8% by mass or less.
(5) With regard to any one of the above-described items (1) to (4), from the viewpoint of the lateral pressure characteristics, the primary resin layer may have a Young's modulus of 0.7 MPa or less at 23° C.
(6) With regard to any one of the above-described items (1) to (5), the optical fiber may have an outer diameter of 150 μm or more and 200 μm or less.
(7) With regard to any one of the above-described items (1) to (6), from the viewpoint of a high-density cable, the glass fiber may include a plurality of cores.
(8) An optical fiber ribbon according to an embodiment of the present disclosure includes a plurality of the optical fibers according to any one of the above-described items (1) to (7) arranged in parallel; and a connecting resin layer coating and connecting the plurality of optical fibers. As a result, an optical fiber ribbon that includes optical fibers having excellent distinguishability can be provided.
(9) An optical fiber cable according to an embodiment of the present disclosure has the optical fiber ribbon according to the above-described item (8) housed within a cable. As a result, an optical fiber cable that includes optical fibers having excellent distinguishability can be provided.

### Details of Embodiments of Present Disclosure

Specific examples of the optical fiber and the optical fiber ribbon according to the embodiments of the present disclosure will be described, with reference to the drawings as necessary. The present disclosure is not limited to these examples, and it is intended that all modifications within the meaning and scope equivalent to the claims as shown by the claims. In the following description, the same reference numerals will be given to the same elements in the description of the drawings, and duplicated descriptions will not be repeated. In the present embodiment, the term (meth)acrylate means acrylate or methacrylate corresponding thereto, and the same also applies to other similar expressions such as (meth)acrylic acid.

### (Optical Fiber)

The optical fiber according to the present embodiment includes a glass fiber including a core and a cladding, and a coating resin layer covering the glass fiber. The coating resin layer has a primary resin layer coating the glass fiber in contact with the glass fiber, a secondary resin layer coating the primary resin layer, and a colored resin layer coating the secondary resin layer. The colored resin layer contains surface-treated titanium oxide particles in an amount of 1.1% by mass or more and 10% by mass or less based on the total amount (100% by mass) of the colored resin layer. The gel fraction retention ratio of the coating resin layer after the optical fiber according to the present embodiment is subjected to a damp heat test for 60 days in an environment at a temperature of 85° C. and a humidity of 85% is 80% or more.

In a case where the optical fiber is placed in a hot and humid environment, the resin components contained in the coating resin layer are hydrolyzed, causing the coating resin layer to turn yellowish, and the distinguishability of the optical fiber deteriorates, while at the same time, the gel fraction of the coating resin layer is likely to decrease. In particular, a colored resin layer containing titanium oxide tends to be likely to turn yellowish due to the catalytic activity of titanium oxide. In this regard, by incorporating surface-treated titanium oxide particles in a specific range into the colored resin layer, deterioration of the coating resin layer due to damp heat can be suppressed, and the distinguishability of the optical fiber can be maintained. The gel fraction retention ratio of the coating resin layer can be determined by the method described in the Examples. The gel fraction retention ratio of the coating resin layer may be 81% or more, 82% or more, or 83% or more.

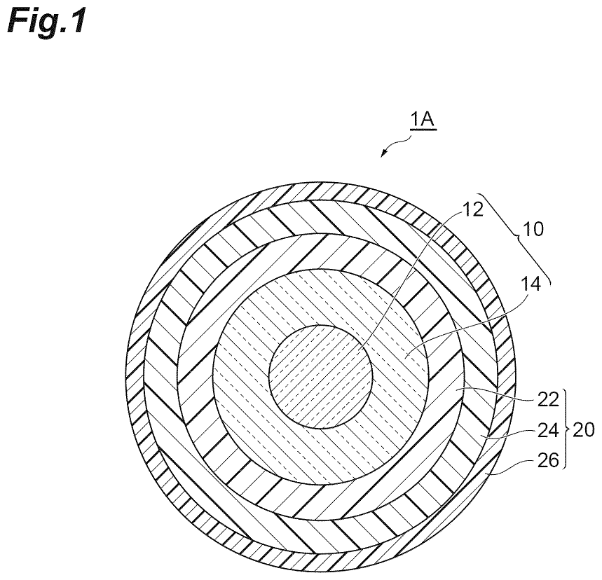

FIG. 1 is a schematic cross-sectional view showing an example of the optical fiber according to the present embodiment. As shown in FIG. 1, the optical fiber 1A includes a glass fiber 10 and a coating resin layer 20 covering the outer periphery of the glass fiber in contact with the glass fiber 10.

The glass fiber 10 includes a core 12 and a cladding 14, and the cladding 14 surrounds the core 12. The core 12 and the cladding 14 mainly contain glass such as silica glass, and for example, germanium-doped silica glass, or pure silica glass can be used for the core 12, while pure silica glass or fluorinated silica glass can be used for the cladding 14.

In FIG. 1, for example, the outer diameter of the glass fiber 10 may be 100 μm or more and 125 μm or less, and the diameter of the core 12 constituting the glass fiber 10 may be 7 μm or more and 15 μm or less. From the viewpoint of increasing the density of the optical cable, the outer diameter of the optical fiber 1A may be 150 μm or more and 220 μm or less, 150 μm or more and 200 μm or less, or 150 μm or more and 190 μm or less.

FIG. 1 shows an optical fiber including a glass fiber having a single core; however, the optical fiber according to the present embodiment may be an optical fiber including a glass fiber having a plurality of cores (hereinafter, also referred to as “multicore optical fiber”). A multicore optical fiber is an optical fiber in which a plurality of cores extending in the fiber axial direction are covered with a common cladding. In the multicore optical fiber, the materials for the plurality of cores may be each the same or may be different. The outer diameter of the glass fiber in the multicore optical fiber may be, for example, 170 μm or more and 190 μm or less, and the outer diameter of the multicore optical fiber may be, for example, 200 μm or more and 250 μm or less.

The coating resin layer 20 is an ultraviolet-curable resin layer covering the cladding 14. The coating resin layer 20 includes a primary resin layer 22 coating the outer periphery of the glass fiber 10, a secondary resin layer 24 coating the outer periphery of the primary resin layer 22, and a colored resin layer 26 coating the outer periphery of the secondary resin layer 24. The primary resin layer 22 is in contact with the outer peripheral surface of the cladding 14 and coats the entirety of the cladding 14. The secondary resin layer 24 is in contact with the outer peripheral surface of the primary resin layer 22 and coats the entirety of the primary resin layer 22. The colored resin layer 26 is in contact with the outer peripheral surface of the secondary resin layer 24 and coats the entirety of the secondary resin layer 24.

The thickness of the primary resin layer 22 is, for example, 10 μm or more and 50 μm or less. The thickness of the secondary resin layer 24 is, for example, 10 μm or more and 40 μm or less. From the viewpoint of increasing the packing density of the optical fiber, the thickness of the colored resin layer 26 may be 2 μm or more and 10 μm or less, 3 μm or more and 8 μm or less, or 4 μm or more and 6 μm or less.

The colored resin layer 26 can be formed by curing a resin composition (hereinafter, also referred to as “resin composition for colored resin layer”) containing a photopolymerizable compound, a photopolymerization initiator, and surface-treated titanium oxide particles. The colored resin layer according to the present embodiment contains a cured product of the resin composition for colored resin layer. When the content of the surface-treated titanium oxide particles is 1.1% by mass or more and 10% by mass or less based on the total amount of the colored resin layer, the distinguishability of the optical fiber can be improved. The surface-treated titanium oxide particles are particles in which titanium oxide has been subjected to a surface treatment with an inorganic substance. Examples of the structure of titanium oxide include an anatase structure, a rutile structure, and a brookite structure; however, from the viewpoint of stability, titanium oxide having a rutile structure is desirable.

Examples of the inorganic substance used for the surface treatment include aluminum oxide, silicon dioxide, and zirconium dioxide. When the surface-treated titanium oxide particles have a surface treatment layer containing at least one selected from the group consisting of aluminum oxide, silicon dioxide, and zirconium dioxide, the catalytic activity of titanium oxide can be suppressed, and a color change in the colored resin layer caused by damp heat deterioration can be prevented. The surface treatment layer may be formed on at least a portion of the surface of the titanium oxide particles, or may be formed over the entire surface of the titanium oxide particles. The surface treatment layer is formed by a surface treatment of the titanium oxide particles.

From the viewpoint of improving dispersibility, the amount of the surface treatment layer in the surface-treated titanium oxide particles may be 1% by mass or more, 1.5% by mass or more, 1.8% by mass or more, or 1.9% by mass or more, and from the viewpoint of enhancing the covering power, the amount may be 10% by mass or less, 9% by mass or less, 8% by mass or less, or 6% by mass or less. The amount of the surface treatment layer can be calculated by measuring the amounts of titanium element and elements of inorganic substances other than titanium contained in the surface-treated titanium oxide particles by using inductively coupled mass spectrometry (ICP-MS). From the viewpoint of further suppressing a change in coloration of the optical fiber, the surface treatment layer may contain aluminum oxide, and the content of aluminum oxide in the surface-treated titanium oxide particles may be 1% by mass or more and 8% by mass or less, 1.5% by mass or more and 7% by mass or less, 1.8% by mass or more and 6% by mass or less, or 1.9% by mass or more and 5.5% by mass or less.

From the viewpoint of improving the lateral pressure resistance of the optical fiber, the average primary particle size of the surface-treated titanium oxide particles may be 300 nm or less, 295 nm or less, 290 nm or less, or 280 nm or less. From the viewpoint of enhancing the covering power, the average primary particle size of the surface-treated titanium oxide particles may be 100 nm or more, 150 nm or more, 200 nm or more, or 220 nm or more. The average primary particle size of the surface-treated titanium oxide particles may be, for example, 200 nm or more and 300 nm or less, 200 nm or more and 290 nm or less, or 220 nm or more and 280 nm or less. The average primary particle size can be measured by, for example, image analysis of electron micrographs, a light scattering method, or a BET method.

From the viewpoint of improving the visibility of the colored resin layer, the content of the surface-treated titanium oxide particles may be 1.3% by mass or more, 1.5% by mass or more, 1.8% by mass or more, 1.9% by mass or more, or 2.0% by mass or more, based on the total amount of the colored resin layer. From the viewpoint of enhancing the curability of the colored resin layer, the content of the surface-treated titanium oxide particles may be 9.5% by mass or less, 9.0% by mass or less, 8.5% by mass or less, 8.0% by mass or less, or 6.0% by mass or less, based on the total amount of the colored resin layer.

From the viewpoint of adjusting the Young's modulus, the photopolymerizable compound according to the present embodiment may contain a urethane (meth)acrylate. As the urethane (meth)acrylate, a urethane oligomer obtained by reacting a polyol compound, a polyisocyanate compound, and a hydroxyl group-containing (meth)acrylate compound can be used. Examples of the urethane (meth)acrylate include an aromatic urethane (meth)acrylate having an aromatic ring, and an aliphatic urethane (meth)acrylate having no aromatic ring. Regarding the urethane (meth)acrylate, two or more kinds thereof may be used as a mixture.

Examples of the polyol compound include polytetramethylene glycol, polypropylene glycol, and bisphenol A-ethylene oxide-added diol. Examples of the polyisocyanate compound include 2,4-tolylene diisocyanate, 2,6-tolylene diisocyanate, isophorone diisocyanate, and dicyclohexylmethane 4,4′-diisocyanate. Examples of the hydroxyl group-containing (meth)acrylate compound include 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol mono(meth)acrylate.

From the viewpoint of adjusting the Young's modulus of the resin layer, the number average molecular weight (Mn) of the polyol compound may be 300 or more and 5000 or less, 400 or more and 4000 or less, 500 or more and 3000 or less, or 600 or more and 2500 or less.

As a catalyst at the time of synthesizing urethane (meth)acrylate, an organotin compound is generally used. Examples of the organotin compound include dibutyltin dilaurate, dibutyltin diacetate, dibutyltin malate, dibutyltin bis(2-ethylhexyl mercaptoacetate), dibutyltin bis(isooctyl mercaptoacetate), and dibutyltin oxide. In view of easy availability or catalyst performance, dibutyltin dilaurate or dibutyltin diacetate may be used as the catalyst.

When urethane (meth)acrylate is synthesized, a lower alcohol having 5 or fewer carbon atoms may be used. Examples of the lower alcohol include methanol, ethanol, 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, and 2,2-dimethyl-1-propanol.

The photopolymerizable compound according to the present embodiment may further include an epoxy (meth)acrylate. Examples of the epoxy (meth)acrylate include an aliphatic epoxy (meth)acrylate and an aromatic epoxy (meth)acrylate. An aliphatic epoxy (meth)acrylate means an epoxy (meth)acrylate that does not have an aromatic ring, and an aromatic epoxy (meth)acrylate means an epoxy (meth)acrylate having an aromatic ring.

As the aliphatic epoxy (meth)acrylate, a reaction product of an aliphatic epoxy compound having two or more glycidyl groups and a compound having a (meth)acryloyl group, such as (meth)acrylic acid, can be used.

From the viewpoint of increasing the toughness of the resin layer, the aliphatic epoxy (meth)acrylate may have an ethylene oxide group or a propylene oxide group. Examples of the aliphatic epoxy (meth)acrylate include a (meth)acrylic acid adduct of propylene glycol diglycidyl ether, a (meth)acrylic acid adduct of polypropylene glycol diglycidyl ether, a (meth)acrylic acid adduct of ethylene glycol diglycidyl ether, and a (meth)acrylic acid adduct of polyethylene glycol diglycidyl ether.

Examples of commercially available products of the aliphatic epoxy (meth)acrylate include trade names “EPOXY ESTER 40EM”, “EPOXY ESTER 70PA”, “EPOXY ESTER 200PA”, and “EPOXY ESTER 80MFA” manufactured by Kyoeisha Chemical Co., Ltd.

As the aromatic epoxy (meth)acrylate, a reaction product of an aromatic epoxy compound having two or more glycidyl groups and a compound having a (meth)acryloyl group, such as (meth)acrylic acid, can be used. Examples of the aromatic epoxy (meth)acrylate include a (meth)acrylic acid adduct of bisphenol A diglycidyl ether.

The photopolymerizable compound according to the present embodiment can include a photopolymerizable compound other than a urethane (meth)acrylate and an epoxy (meth)acrylate (hereinafter, referred to as “monomer”).

As the monomer, a monofunctional monomer having one polymerizable group, or a polyfunctional monomer having two or more polymerizable groups can be used. Regarding the monomer, two or more kinds thereof may be used as a mixture.

Examples of the monofunctional monomer include (meth)acrylate-based monomers such as methyl (meth)acrylate, ethyl (meth)acrylate, propyl (meth)acrylate, n-butyl (meth)acrylate, s-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, 2-phenoxyethyl (meth)acrylate, 3-phenoxybenzyl acrylate, phenoxy diethylene glycol acrylate, phenoxy polyethylene glycol acrylate, 4-tert-butylcyclohexanol acrylate, tetrahydrofurfuryl (meth)acrylate, benzyl (meth)acrylate, dicyclopentenyl (meth)acrylate, dicyclopentenyloxyethyl (meth)acrylate, dicyclopentanyl (meth)acrylate, nonylphenol polyethylene glycol (meth)acrylate, nonylphenoxy polyethylene glycol (meth)acrylate, and isobornyl (meth)acrylate; carboxy group-containing monomers such as (meth)acrylic acid, (meth)acrylic acid dimer, carboxyethyl (meth)acrylate, carboxypentyl (meth)acrylate, ω-carboxy-polycaprolactone (meth)acrylate; heterocyclic ring-containing monomers such as N-(meth)acryloylmorpholine, N-vinylpyrrolidone, N-vinylcaprolactam, N-(meth)acryloylpiperidine, N-(meth)acryloylpyrrolidine, 3-(3-pyridine) propyl (meth)acrylate, and cyclic trimethylolpropane formal acrylate; maleimide-based monomers such as maleimide, N-cyclohexylmaleimide, and N-phenylmaleimide; amide-based monomers such as (meth)acrylamide, N,N-dimethyl(meth)acrylamide, N,N-diethyl(meth)acrylamide, N-hexyl(meth)acrylamide, N-methyl(meth)acrylamide, N-ethyl(meth)acrylamide, N-butyl(meth)acrylamide, N-methylol (meth)acrylamide, and N-methylolpropane (meth)acrylamide; aminoalkyl (meth)acrylate-based monomers such as aminoethyl (meth)acrylate, aminopropyl (meth)acrylate, N,N-dimethylaminoethyl (meth)acrylate, and tert-butylaminoethyl(meth)acrylate; and succinimide-based monomers such as N-(meth)acryloyloxymethylene succinimide, N-(meth)acryloyl-6-oxyhexamethylene succinimide, and N-(meth)acryloyl-8-oxyoctamethylene succinimide.

Examples of the polyfunctional monomer include ethylene glycol di(meth)acrylate, polyethylene glycol di(meth)acrylate, polypropylene glycol di(meth)acrylate, neopentyl glycol di(meth)acrylate, tripropylene glycol di(meth)acrylate, di(meth)acrylate of an alkylene oxide adduct of bisphenol A, tetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyldiol di(meth)acrylate, 3-ethyl-1,8-octanediol di(meth)acrylate, EO adduct di(meth)acrylate of bisphenol A, trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate.

The photopolymerization initiator can be appropriately selected from known radical photopolymerization initiators and used. Examples of the photopolymerization initiator include 1-hydroxycyclohexyl phenyl ketone (Omnirad 184, manufactured by IGM Resins BV), 2,2-dimethoxy-2-phenylacetophenone, 1-(4-isopropylphenyl)-2-hydroxy-2-methylpropan-1-one, bis(2,6-dimethoxybenzoyl)-2,4,4-trimethylpentylphosphine oxide, 2-methyl-1-[4-(methylthio)phenyl]-2-morpholinopropan-1-one (Omnirad 907, manufactured by IGM Resins BV), 2,4,6-trimethylbenzoyldiphenylphosphine oxide (Omnirad TPO, manufactured by IGM Resins BV), and bis(2,4,6-trimethylbenzoyl)phenylphosphine oxide (Omnirad 819, manufactured by IGM Resins BV).

The content of the photopolymerization initiator may be 1% by mass or more and 12% by mass or less, 2% by mass or more and 10% by mass or less, or 3% by mass or more and 8% by mass or less, based on the total amount of the resin composition.

The resin composition according to the present embodiment may further contain a silane coupling agent, a leveling agent, an antifoaming agent, an antioxidant, a sensitizer, and the like.

The silane coupling agent is not particularly limited so long as it does not interrupt with the curing of the resin composition. Examples of the silane coupling agent include tetramethyl silicate, tetraethyl silicate, mercaptopropyltrimethoxysilane, vinyltrichlorosilane, vinyltriethoxysilane, vinyltris(β-methoxy-ethoxy) silane, β-(3,4-epoxycyclohexyl)-ethyltrimethoxysilane, dimethoxydimethylsilane, diethoxydimethylsilane, 3-acryloxypropyltrimethoxysilane, γ-glycidoxypropyltrimethoxysilane γ-glycidoxypropylmethyldiethoxysilane, γ-methacryloxypropyltrimethoxysilane, N-(β-aminoethyl)-γ-aminopropyltrimethoxysilane, N-(β-aminoethyl)-γ-aminopropyltrimethyldimethoxysilane, N-phenyl-γ-aminopropyltrimethoxysilane, γ-chloropropyltrimethoxysilane, γ-mercaptopropyltrimethoxysilane, γ-aminopropyltrimethoxysilane, bis-[3-(triethoxysilyl) propyl] tetrasulfide, bis-[3-(triethoxysilyl) propyl] disulfide, γ-trimethoxysilylpropyldimethylthiocarbamyl tetrasulfide, and γ-trimethoxysilylpropylbenzothiazyl tetrasulfide.

The primary resin layer 22 can be formed by, for example, curing a resin composition containing a urethane (meth)acrylate, a monomer, a photopolymerization initiator, and a silane coupling agent (hereinafter, also referred to as “resin composition for primary resin layer”). The resin composition for primary resin layer can use a conventionally known technology. The urethane (meth)acrylate, monomer, photopolymerization initiator, and silane coupling agent may be appropriately selected from the compounds listed above as examples. As the urethane (meth)acrylate, an aromatic urethane (meth)acrylate having a structure based on 2,4-tolylene diisocyanate or 2,6-tolylene diisocyanate may be used.

The secondary resin layer 24 can be formed by curing a resin composition containing a urethane (meth)acrylate, a monomer, and a photopolymerization initiator (hereinafter, also referred to as “resin composition for secondary resin layer”). The resin composition for secondary resin layer can use a conventionally known technology. The urethane (meth)acrylate, monomer, and photopolymerization initiator may be appropriately selected from the compounds listed above as examples. As the urethane (meth)acrylate, an aromatic urethane (meth)acrylate having a structure based on 2,4-tolylene diisocyanate or 2,6-tolylene diisocyanate may be used.

From the viewpoint of improving the lateral pressure characteristics of the optical fiber, it is desirable that the Young's modulus of the primary resin layer is low, while the Young's modulus of the secondary resin layer is high. The Young's modulus of the primary resin layer may be 0.7 MPa or less, 0.5 MPa or less, or 0.4 MPa or less at 23° C. The lower limit value of the Young's modulus of the primary resin layer may be 0.05 MPa or more. The Young's modulus of the secondary resin layer may be 1000 MPa or more, 1100 MPa or more, or 1200 MPa or more at 23° C.

### (Optical Fiber Ribbon)

An optical fiber ribbon can be produced using the optical fiber according to the present embodiment. In the optical fiber ribbon, a plurality of the above-described optical fibers are arranged in parallel and covered with a resin for ribbon.

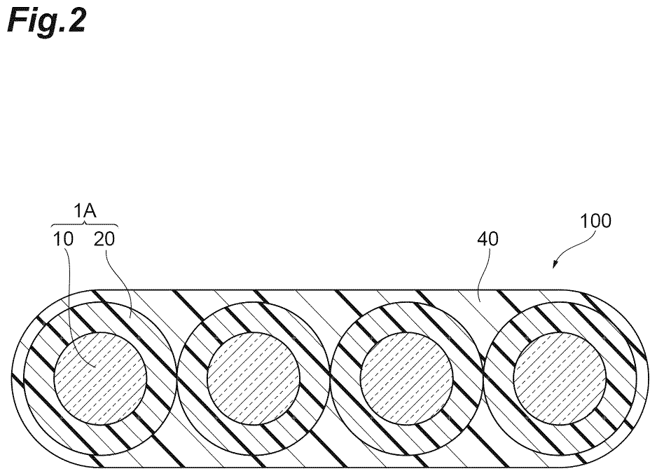

FIG. 2 is a schematic cross-sectional view showing an optical fiber ribbon according to the present embodiment. The optical fiber ribbon 100 has a plurality of optical fibers 1A and a connecting resin layer 40 in which the optical fibers 1A are coated with a resin for ribbon and connected. In FIG. 2, four optical fibers are shown as an example; however, the number thereof is not particularly limited.

As the resin for ribbon, a resin material that is generally known as a ribbon material can be used. From the viewpoints of the property of preventing damage to the optical fiber, ease of separation, and the like, the resin for ribbon may contain thermosetting resins such as a silicone resin, an epoxy resin, and a urethane resin; or ultraviolet-curable resins such as an epoxy (meth)acrylate, a urethane (meth)acrylate, and a polyester (meth)acrylate.

In the optical fiber ribbon according to the present embodiment, by using the above-described optical fiber, damp heat deterioration of the coating resin layer can be suppressed, and the optical fibers can be easily distinguished.

### (Optical Fiber Cable)

In an optical fiber cable according to the present embodiment, the above-described optical fiber ribbon is housed within the cable. Examples of the optical fiber cable include a slotted optical fiber cable having a plurality of slots. Within the slots, the above-described optical fiber ribbon can be packaged such that the packaging density in each slot is about 25% to 65%. The packaging density means the proportion of the cross-sectional area of the optical fiber ribbon packaged within the slots with respect to the cross-sectional area of the slots. The optical fiber cable according to the present embodiment may be in a form in which the above-described plurality of optical fibers are housed within the cable without being coated with a resin for ribbon.

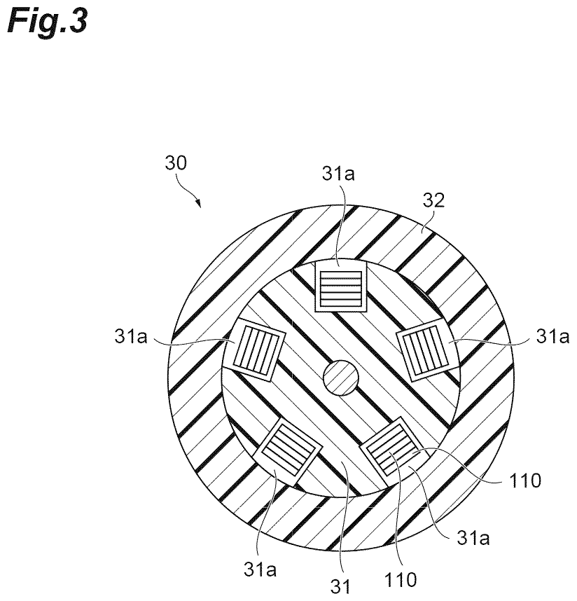

FIG. 3 is a schematic cross-sectional view showing an example of the optical fiber cable according to the present embodiment. The optical fiber cable 30 includes a spacer 31 and a sheath 32. The spacer 31 extends along the longitudinal direction of the optical fiber cable 30 and has a plurality of slots 31a. The plurality of slots 31a are formed along the longitudinal direction of the optical fiber cable 30 on the outer peripheral surface of the spacer 31. The slots 31a accommodate a plurality of optical fiber ribbons 110. The sheath 32 extends along the longitudinal direction of the optical fiber cable 30 and covers the periphery of the spacer 31. The sheath 32 is formed of, for example, polyvinyl chloride or polyethylene.

### EXAMPLES

Hereinafter, the results of evaluation tests using Examples and Comparative Examples according to the present disclosure will be shown, and the present disclosure will be described in more detail. Meanwhile, the present disclosure is not limited to these Examples.

As titanium oxide particles, titanium oxide particles (Ti-1) to (Ti-6) having the surface treatment layers shown in Table 1, and titanium oxide particles (Ti-7) that were not surface-treated were prepared. The amount of Al₂O₃ was calculated by quantitatively determining Ti element and Al element contained in the surface-treated titanium oxide particles using a high-frequency inductively coupled plasma optical emission spectrometer (“ICP-MS Agilent 7700×” of Agilent Technologies, Inc.).

TABLE 1

| | Ti-1 | Ti-2 | Ti-3 | Ti-4 | Ti-5 | Ti-6 | Ti-7 |
|---|---|---|---|---|---|---|---|
| Average primary | 250 | 250 | 250 | 250 | 250 | 250 | 250 |
| particle size (nm) | | | | | | | |
| Surface treatment | Al₂O₃ | Al₂O₃ | Al₂O₃ | Al₂O₃ | Al₂O₃ | Al₂O₃ | — |
| layer | | | | | | SiO₂ | |
| Amount of Al₂O₃ | 1.0 | 2.0 | 3.0 | 4.0 | 5.0 | 3.0 | — |
| (% by mass) | | | | | | | |

### (Resin Composition for Colored Resin Layer)

75 parts by mass of a urethane acrylate, which was a reaction product of a polypropylene glycol having a molecular weight of 1000, 2,4-tolylene diisocyanate, and 2-hydroxyethyl acrylate, 10 parts by mass of bisphenol A-ethylene oxide-added diol diacrylate, 7 parts by mass of isobornyl acrylate, 1 part by mass of 2,4,6-trimethylbenzoyldiphenylphosphine oxide (Omnirad TPO, manufactured by IGM Resins BV), and 4 parts by mass of 1-hydroxycyclohexyl phenyl ketone (Omnirad 184, manufactured by IGM Resins BV) were mixed, and then titanium oxide particles were mixed therewith such that the content of the titanium oxide particles in the colored resin layer was the amount (% by mass) shown in Table 2, to produce a resin composition for colored layer.

### (Resin Composition for Primary Coating)

75 parts by mass of a urethane acrylate, which was a reaction product of a polypropylene glycol having a molecular weight of 4000, 2,4-tolylene diisocyanate, and 2-hydroxyethyl acrylate, 17 parts by mass of nonylphenol EO-modified (meth)acrylate, 7 parts by mass of N-vinylcaprolactam, 2 parts by mass of Omnirad TPO, and 1 part by mass of γ-mercaptotrimethoxysilane were mixed to produce a resin composition P for primary resin layer.

### (Resin Composition for Secondary Resin Layer)

60 parts by mass of a urethane acrylate, which was a reaction product of a polypropylene glycol having a molecular weight of 1000, 2,4-tolylene diisocyanate, and 2-hydroxyethyl acrylate, 19 parts by mass of isobornyl acrylate, 20 parts by mass of trimethylolpropane triacrylate, and 1 part by mass of Omnirad TPO were mixed to produce a resin composition S for secondary resin layer.

### [Optical Fiber]

On the outer periphery of a glass fiber composed of a core and a cladding and having a diameter of 125 μm, a primary resin layer having a thickness of 17.5 μm was formed using the resin composition P, and a secondary resin layer having a thickness of 15 μm was further formed on the periphery of the primary resin layer using the resin composition S, to obtain an optical fiber. Next, after the optical fiber was once wound up, a colored resin layer having a thickness of 5 μm was formed using a coloring machine on the outer periphery of the secondary resin layer using the resin compositions of Test Examples 1 to 10 while paying out the optical fiber again, and thereby an optical fiber having a diameter of 200 μm and having a colored resin layer (hereinafter, referred to as “colored optical fiber”) was produced. The linear velocity at the time of forming each resin layer was set to 1500 m/min. Test Examples 1 to 6 correspond to Examples, and Test Examples 7 to 10 correspond to Comparative Examples. Incidentally, the resin composition of Test Example 10 was cured insufficiently and could not form a colored resin layer, and therefore, a colored optical fiber could not be produced.

### (Gel Fraction)

The colored optical fiber was immersed in methyl ethyl ketone at 60° C. for 12 hours to extract uncured components in the coating resin layer. The optical fiber was taken out, subsequently methyl ethyl ketone was removed with a vacuum dryer, and the gel fraction was determined from the following formula.

$$Gel fraction [ \% ] = ( Mass of colored optical fiber after extraction - mass of glass fiber ) / ( mass of colored optical fiber before extraction - mass of glass fiber ) \times 100$$

Next, the gel fraction after the colored optical fiber was subjected to a damp heat test for 60 days in an environment at a temperature of 85° C. and a humidity of 85% was measured. The ratio of the gel fractions before and after the damp heat test was defined as gel fraction retention ratio.

### (Resin Composition for Ribbon)

A urethane acrylate a obtained by reacting 1 mol of bisphenol A-ethylene oxide-added diol, 2 mol of 2,4-tolylene diisocyanate, and 2 mol of hydroxyethyl acrylate, and a urethane acrylate b obtained by reacting 1 mol of polytetramethylene glycol, 2 mol of 2,4-tolylene diisocyanate, and 2 mol of hydroxyethyl acrylate, were prepared. 18 parts by mass of the urethane acrylate a, 10 parts by mass of the urethane acrylate b, 15 parts by mass of tricyclodecane diacrylate, 10 parts by mass of N-vinylpyrrolidone, 10 parts by mass of isobornyl acrylate, 5 parts by mass of bisphenol A-ethylene oxide-added diol diacrylate, 0.7 parts by mass of Omnirad 907, and 1.3 parts by mass of Omnirad TPO were mixed to obtain a resin composition R.

### [Production of Optical Fiber Ribbon]

A connecting resin layer having a thickness of 10 μm was formed around twelve optical fibers arranged in parallel using the resin composition R, and an optical fiber ribbon was produced.

### (Distinguishability)

A damp heat test of the optical fiber ribbon was performed in an environment at a temperature of 85° C. and a humidity of 85%, and distinguishability was evaluated by checking the color change of the optical fibers. A case in which the colors (yellow and brown) of the optical fibers could be distinguished even after 60 days was rated as “A”, and a case in which the colors of the optical fibers could not be distinguished after 60 days was rated as “B”.

TABLE 2

| | Titanium | | Gel fraction | |
|---|---|---|---|---|
| | oxide particles | | retention | |
| Test | | Content | ratio | Distinguish- |
| Example | Type | (% by mass) | (%) | ability |
| 1 | Ti-2 | 2.0 | 80 | A |
| 2 | Ti-3 | 2.0 | 83 | A |
| 3 | Ti-4 | 2.0 | 85 | A |
| 4 | Ti-5 | 2.0 | 88 | A |
| 5 | Ti-5 | 8.0 | 81 | A |
| 6 | Ti-6 | 2.0 | 84 | A |
| 7 | Ti-7 | 2.0 | 50 | B |
| 8 | Ti-1 | 2.0 | 70 | B |
| 9 | Ti-3 | 1.0 | 85 | B |
| 10 | Ti-5 | 12.0 | — | — |

### REFERENCE SIGNS LIST

1A: optical fiber
10: glass fiber
12: core
14: cladding
20: coating resin layer
22: primary resin layer
24: secondary resin layer
26: colored resin layer
30: optical fiber cable
31: spacer
31a: slot
32: sheath
40: connecting resin layer
100, 110: optical fiber ribbon

What is claimed is:

1. An optical fiber comprising:
a glass fiber including a core and a cladding; and
a coating resin layer covering the glass fiber,
wherein the coating resin layer has a primary resin layer coating the glass fiber in contact with the glass fiber, a secondary resin layer coating the primary resin layer, and a colored resin layer coating the secondary resin layer,
the colored resin layer contains surface-treated titanium oxide particles in an amount of 1.1% by mass or more and 10% by mass or less based on a total amount of the colored resin layer, and
a gel fraction retention ratio of the coating resin layer after the optical fiber is subjected to a damp heat test for 60 days in an environment at a temperature of 85° C. and a humidity of 85% is 80% or more.

2. The optical fiber according to claim 1, wherein the colored resin layer has a thickness of 2 μm or more and 10 μm or less.

3. The optical fiber according to claim 1, wherein the surface-treated titanium oxide particles have a surface treatment layer containing at least one selected from the group consisting of aluminum oxide, silicon dioxide, and zirconium dioxide.

4. The optical fiber according to claim 3, wherein the surface-treated titanium oxide particles have a surface treatment layer containing aluminum oxide, and a content of the aluminum oxide in the surface-treated titanium oxide particles is 1% by mass or more and 8% by mass or less.

5. The optical fiber according to claim 1, wherein the primary resin layer has a Young's modulus of 0.7 MPa or less at 23° C.

6. The optical fiber according to claim 1, wherein the optical fiber has an outer diameter of 150 μm or more and 200 μm or less.

7. The optical fiber according to claim 1, wherein the glass fiber includes a plurality of the cores.

8. An optical fiber ribbon comprising:
a plurality of the optical fibers according to claim 1 arranged in parallel; and
a connecting resin layer coating and connecting the plurality of optical fibers.

9. An optical fiber cable comprising the optical fiber ribbon according to claim 8 housed within a cable.
